(19) United States
(12) Patent Application Publication
(10) Pub. No.: US 2009/0130339 A1
(43) Pub. Date: May 21, 2009

(54) Method for Preparing Electroconductive Particles with Improved Dispersion and Adherence

(76) Inventors: Won Il Son, Daejeon (KR); Dong Ok Kim, Seoul (KR); Jeong Hee Jin, Daejeon (KR); Seok Heon Oh, Daejeon (KR)

Correspondence Address: ABELMAN, FRAYNE & SCHWAB, 666 THIRD AVENUE, 10TH FLOOR, NEW YORK, NY, 10017, US

(21) Appl. No.: 11/991,726

(22) PCT Filed: Oct. 13, 2006
(86) PCT No.: PCT/KR2006/004144

§ 371 Date: Mar. 5, 2008

(30) Foreign Application Priority Data
Oct. 14, 2005 (KR) 10-2005-0097085

(51) Int. Cl. C23C 18/54; B06B 1/20

(52) U.S. Cl. 427/601; 427/443.1

(57) ABSTRACT

The present invention relates to a method of producing electroconductive electroless plating powder having excellent dispersibility and adherence, and, more particularly, to a method of producing electroconductive electroless plating powder having excellent dispersibility and adherence, using an electroless plating method of forming a metal plating layer on the surface of a base material made of resin powder in an electroless plating solution, wherein an ultrasonic treatment is performed at the time of forming the plating layer. The present invention has advantages in that an aggregation phenomenon, which is generated when the base material made of the resin powder is plated using an electroless plating method, does not occur and a plating reaction can be performed at low temperature, so that it is possible to obtain a compact plating layer and plating powder having improved uniformity and adherence with respect to resin powder. Further, the present invention, unlike the conventional technique, has advantages in that post-treatment processes are not performed and a plating reaction is performed at low temperature, so that the process operating cost is reduced and the processes are made simple.

### TECHNICAL FIELD

This application claims the benefit of Korean Patent Application No. 10-2005-0097085, filed on Oct. 14, 2005, entitled “Method for Producing Electroconductive Particles with Improved Dispersion and Adherence”, which is hereby incorporated by reference in its entirety into this application.

The present invention relates to a method of producing electroconductive electroless plating powder having improved dispersibility and adherence, and, more particularly, to a method of producing electroconductive electroless plating powder having improved dispersibility and adherence, in which ultrasonic treatment is performed during an electroless plating process, so that an aggregation phenomenon is prevented and plating reaction temperature can be decreased, with the result that plating powder is not damaged, dispersibility is improved and a plating layer uniformly adheres to resin powder, thereby imparting conductivity.

### BACKGROUND ART

Generally, a resin fine particle material imparted with conductivity is widely used as a member for providing the prevention of an electrostatic phenomenon, the absorption of radio waves and the blocking of electromagnetic waves for electronic devices and the parts thereof. Recently, plating powder has been used as a conductive material for the electrical connection of minute portions of electronic devices, such as the connection of the electrodes of a liquid crystal display panel and large-scale integrated (LSI) chips to circuit boards, and the connection of electrode terminals having minute pitches to each other. A method of physically coating the surface of resin fine particles with metal particles (Japanese Patent Application No. 1993-55263) and a method of embedding the projections of metal powder in the surface of base fine particles (Japanese Patent Application No. 2002-55952) have been used as conventional methods of producing plating powder. Recently, methods of producing plating powder using an electroless plating method have been mainly used (Japanese Patent Application No. 2003-103494, Japanese Patent Application No. 2003-57391, and Japanese Patent Application No. 2001-394798).

However, electroconductive plating powder, such as gold, silver or nickel powder, which can be obtained using the conventional methods, has problems in that base particles are aggregated during a plating process, and the hydrophobic property of a metal layer is increased due to the increase in the film thickness of a metal plating layer, and thus an aggregation phenomenon is increased, thereby decreasing dispersibility. Furthermore, it has problems in that, when the aggregation of electroconductive particles is not completely prevented, leakage occurs between neighboring electrodes or between neighboring wires, and bridging due to electroconductive fine particles occurs. Further, the electroconductive powder plated with nickel etc. has problems in that a plating reaction temperature is approximately 60° C. or more, so that a compact plating layer cannot easily be obtained, with the result that the plating layer is easily separated from resin powder, and with the result that the plating layer is separated from the resin powder when the electroconductive powder is pressed to a substrate or electrode terminals, thereby reducing conductivity.

The conventional method is intended to increase dispersibility through high precision classification processing which uses sieve classification after mechanical dispersion treatment using an air current type grinder, a water current type grinder, a ball mill, a bead mill, an ultrasonic grinder, or the like, in order to remove aggregated conductive particles and thus improve dispersibility. However, there are disadvantages in that the grinding process is a factor that breaks a metal film formed on the surface of particles and thus decreases conductivity, it is difficult to completely remove aggregates formed during the producing process even though the classification processing is performed, and process operation costs much and is complicated.

Recently, since the wires of a substrate etc. are becoming minute due to the rapid development of electronic devices and the miniaturization of electronic parts, electroconductive powder having high dispersibility and high adherence between a metal coating layer and resin powder is required.

### DISCLOSURE

### Technical Problem

The present inventors have performed research on the development of electroconductive powder having improved dispersibility and adherence, and thus have found that, when ultrasonic treatment is performed during an electroless plating process, an aggregation phenomenon is prevented and plating reaction temperature can be decreased, therefore electoconductive powder which has high dispersibility and in which a plating layer adheres uniformly to resin powder can be obtained. Accordingly, the present invention has been completed based on these findings.

Accordingly, an object of the present invention is to provide a method of producing electroconductive powder having improved dispersibility and adherence, which can meet the demand for minute wires, has sufficient electric capacity at the time of connection, and does not generate a leakage phenomenon, thereby imparting high conductivity.

### Technical Solution

In order to accomplish the above object, the present invention provides a method of producing electroconductive electroless plating powder having excellent dispersibility and adherence, using an electroless plating method of forming a metal plating layer on the surface of a base material made of resin powder in an electroless plating solution, wherein an ultrasonic treatment is performed at the time of forming the plating layer.

### ADVANTAGEOUS EFFECT

According to the present invention, an ultrasonic treatment is performed using an ultrasonic dispersion apparatus during electroless plating, so that an aggregation phenomenon does not occur during plating with fine particles, and a plating reaction can be performed at low temperature, with the result that it is possible to obtain a compact plating layer and plating powder having improved uniformity and adherence with respect to resin powder. Accordingly, the present invention provides high grade electroconductive electroless plating powder which can meet the demand for minute wires, has sufficient electric capacity at the time of connection, and does not generate a leakage phenomenon. Further, unlike the conventional technique, post-treatment processes are not performed and a plating reaction is performed at low temperature, so that there are advantages in that the process operating cost is reduced and the processes are made simple, with the result that it is expected that the present invention will have high industrial availability.

### DESCRIPTION OF DRAWINGS

FIG. 1 is a photograph of a 1000× magnification of the surface of plating powder taken using a Scanning Electron Microscope (SEM) according to an example of the present invention;

FIG. 2 is a photograph of a 1000× magnification of the surface of plating powder taken using a Scanning Electron Microscope (SEM) according to another example of the present invention;

FIG. 3 is a photograph of a 1000× magnification of the surface of plating powder taken using a Scanning Electron Microscope (SEM) according to a further example of the present invention;

FIG. 4 is a photograph of a 1000× magnification of the surface of plating powder taken using a Scanning Electron Microscope (SEM) according to a further example of the present invention;

FIG. 5 is a photograph of a 1000× magnification of the surface of plating powder taken using a Scanning Electron Microscope (SEM) according to a further example of the present invention;

FIG. 6 is a photograph of a 1000× magnification of the surface of plating powder taken using a Scanning Electron Microscope (SEM) according to a further example of the present invention;

FIG. 7 is a photograph of a 1000× magnification of the surface of plating powder taken using a Scanning Electron Microscope (SEM) according to a conventional method;

FIG. 8 is a photograph of a 1000× magnification of the surface of plating powder taken using a Scanning Electron Microscope (SEM) according to another conventional method; and

FIG. 9 is a photograph of a 1000× magnification of the surface of plating powder taken using a Scanning Electron Microscope (SEM) according to a further conventional method.

### BEST MODE

The present invention will be described in more detail below.

As described above, the present invention is based on the notion that, when an ultrasonic treatment is performed at the time of forming a metal plating layer on the surface of base material made of resin powder using an electroless plating method, an aggregation phenomenon between metal particles at the time of plating is prevented and plating reaction temperature can be decreased, therefore a plating layer adheres uniformly to resin powder.

In the present invention, the kinds of resin used as the electroless plating base material are not particularly limited. The resin includes one or a mixture of two or more selected from the group consisting of polyolefins such as polyethylene, polyvinylchloride, polypropylene, polystyrene and polyisobutylene; olefin copolymers such as styrene-acrylonitrile copolymer and acrylonitrile-butadiene-styrene terpolymer, acrylic acid derivative such as poly acrylate, poly methyl methacrylate and poly acrylamide; polyvinyl-based compounds such as polyvinyl acetate and polyvinyl alcohol; ether polymers such as poly acetal, polyethylene glycol, polypropylene glycol and epoxy resin; amino compounds such as benzoguanamine, urea, thio urea, melamine, acetoguanamine, dicyan amide and aniline; aldehydes such as formaldehyde, palladium formaldehyde and acetaldehyde; polyurethane; and polyesters.

According to the present invention, the resin powder used in the invention has an average particle size in a range of 0.5˜1000 μm. The average particle size is limited to the above range because if it is less than 0.5 μm, the elecoconductive powder does not contact the surface of electrodes to which is supposed to be bonded and bad contact occurs in the case where gaps exist between the electrodes, and if it is more than 1000 n minute electroconductive bonding cannot be performed. It is preferable that the average particle size be in a range of 1˜100 μm more preferably in a range of 2˜20 μm, and most preferably, in a range of 3˜11 μm.

The aspect ratio of the resin powder is less than 2. It is preferable that the aspect ratio be less than 1.2, and more preferably, less than 1.06. The aspect ratio is limited to the above range because if it is more than 2, the particles which do not contact the electrodes are easily generated in large amounts due to the unevenness of particle sizes at the time of contact of the electroconductive fine particles between the electrodes.

Resin powder having a coefficient of variation (Cv) of particle size of 30% or less, preferably 20% or less, and more preferably 5% or less is used. The coefficient of variation (Cv) of particle size is limited to the above range because if it is more than 30%, particles which do not contact the electrodes are easily generated in large amounts due to the unevenness of particle size at the time of contact of electroconductive fine particles between the electrodes.

The coefficient of variation (Cv) used in the present invention is defined by the following mathematical equation.

Cv (%)=(σ/Dn)×100 Equation 1

Wherein σ represents a standard deviation of the particle size, and Dn represents a number average particle size. The standard deviation and the number average particle size can be calculated using a particle size analysis apparatus (Accusizer model 780-particle sizing systems, Inc).

According to the present invention, a metal film is formed on the surface of resin base material having the characterization of the particles using an electroless plating method. A metal used for the electroless plating is selected from conductive metals, with which electroless plating can be operated, such as Au, Ag, Cu, Ni, Pd, Pt and Sn, and may be an alloy thereof or a multi-layered coating including the two or more conductive metals. Preferably, the metal film is a Ni film or a Ni—Au multi-layered film. The Ni film has excellent adherence to resin base particles and can form an electroless plating layer having separation resistance. Further, Au is easily layered on the upper layer of the Ni film, and the Ni film can be strongly bonded to the plating layer. The Ni—Au multi-layered film has an advantage in that the conductivity thereof is greatly increased compared to a single-layered film. Although the thickness of the single-layered film is in a range of 10˜200 nm, and the thickness of the multi-layered film is in a range of 10˜300 nm, these ranges are not limited thereto.

According to the present invention, an ultrasonic treatment is performed at the time of forming a plating layer on a resin base material. In this case, although the ultrasonic device (sonicator) used for the ultrasonic treatment is not particularly limited, it is preferable that a device having a frequency in the range of 20˜1000 kHz be used. If the frequency of the ultrasonic device is less than 20 kHz, the plating layer formed on the surface of the resin particles will be separated or the plating layer will only be partially formed because ultrasonic waves are extremely strong, and if it is more than 1000 kHz, dispersion is decreased during a plating process due to low dispersibility. It is more preferable that the frequency of the ultrasonic device be in a range of 30˜100 kHz. Ultrasonic devices, which have different wavelengths, that is, can generate frequencies of 30 kHz and 40 kHz, can be used concurrently.

A compound which can decrease the surface tension of resin powder or plating powder (referred to as “a surface tension-reducing compound”) may be added and then used at the time of plating, while the ultrasonic treatment is performed. According to the present invention, the dispersibility of the plating powder can be greatly increased using the surface tension-reducing compound. The surface tension-reducing compound can be added while a complex-forming compound is added, or before or after it is added. Suitable surface tension-reducing compounds include, for example, various types of surfactants, alcohols or the like. One or more may be selected from polyethylene glycol (molecular weight 200˜20,000), polyalkylene alkyl ether, polyalkylene alkyl ethyl, and polyvinylpyrrolidone (molecular weight 500˜400,000) and the like, and may be used as the surface tension-reducing compound. The surface tension-reducing compound is added into a plating solution in an amount of 0.1˜10000 ppm, preferably 0.1˜1000 ppm.

In a method of producing plating powder having excellent dispersibility, although the ultrasonic device is not limited to specific patterns, shapes or sizes, the available ultrasonic device may be may be a bath type, stick type, hollow fiber type, panel type, round type, sheet type, or the like in accordance with the size of the powder, and may be used in a manner of being dipped into the plating solution in a state of being contained in a further bath or directly dipped into the plating solution Particularly, it is preferable that the ultrasonic device be a bath type and be used in a state of being contained a further bath, considering increase in dispersibility.

When the metal film is formed on the surface of resin base material having the characterization of particles concurrently using the electroless plating method and ultrasonic waves according to the present invention, the ultrasonic waves affect the temperature of the plating solution. In this case, when the ultrasonic waves are continuously used, the temperature of the plating solution is increased and the reaction rate of metal deposition is rapidly increased, thus making uniform plating impossible to realize. Accordingly, according to the present invention, uniform plating can be realize by intermittently using the ultrasonic waves or maintaining the plating solution at a low temperature. That is, the temperature of the plating solution is maintained in a range of 40˜70° C., and preferably in a range of 40˜50° C.

Meanwhile, after electroconductive electroless plating powder, in which the metal film is formed on the surface of the particles, is obtained, two or more metal layers can be further formed on the upper layer of the plating film of the electroconductive electroless plating powder.

The electroconductive powder produced based on the present invention is high grade electroconductive electroless plating powder, which can meet the demand for minute wires, has sufficient electric capacity at the time of connection, and does not generate a leakage phenomenon, because it has excellent dispersibility and enables uniform adhesion of the plating layer thereto.

### MODE FOR INVENTION

The method of producing electroconductive powder having excellent dispersibility and adherence, according to the present invention, will be described in more detail below. However, the present invention is not limited to the following examples.

### Example 1

### Pre-Treatment Process for Nickel Plating

Acryl based powder, which has an average particle size of 3.6 μm, an aspect ratio of 1.06 and a coefficient of variation (Cv) of 5% was used. 5 g of the powder was dispersed in a mixed solution of CrO₃ and sulfonic acid, and was treated using an ultrasonic washer for 30 minutes. After the treatment, the powder was deposited for 10 minutes at a temperature of 60° C., and was washed using deionized water. After the washing, the powder was deposited in a SnCl₂ (0.1 g/l) aqueous solution for 3 minutes. After the depositing, the powder was washed using cool deionized water. Then, the powder was deposited in a PdCl₂ (0.1 g/l) aqueous solution for 3 minutes, and was then washed several times using cool deionized water, thereby obtaining a slurry.

<Nickel Plating Process>

A 0.5 M aqueous solution of phosphorous acid salt (NaH₂PO₂) was prepared as a dispersion liquid, the solution was warmed to a temperature of 60° C., and the slurry prepared in the above process was introduced into the solution while the solution was stirred. An electroless plating solution was divided into an A solution (a metal aqueous solution) and a B solution (a reductant) using an electroless plating solution (manufactured by Union Specialty Corporation, Union 440), and 50 ml of the plating solution was slowly added at a rate of 1 ml/min using a microquantitative pump. When several drops of an aqueous solution of nickel sulphate were added, the color of the slurry abruptly changed to black. At this point, an electroless nickel plating was performed by applying ultrasonic waves of 40 kHz using an ultrasonic dispersion device (BRANSON model 5210) while increasing the string velocity and maintaining the pH constant and within a range of 6.0˜6.5. After the nickel sulphate and reductant were completely added, the stirring of the solution and the treating of the ultrasonic waves were continuously performed at a constant temperature until the foaming of the hydrogen stopped.

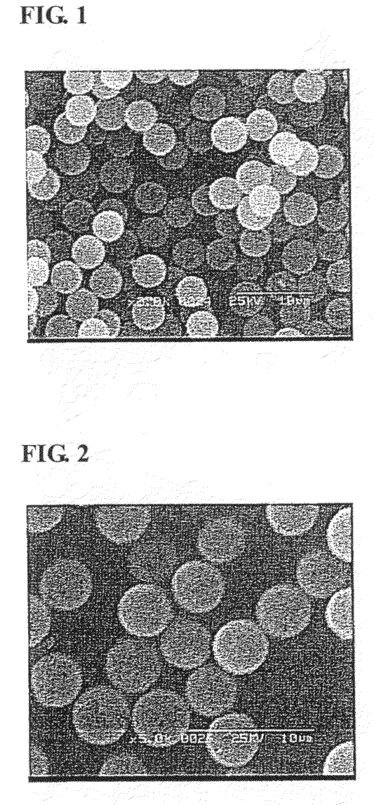

The resulting nickel plating powder was washed in water several times, was substituted with alcohol, and was dried in a vacuum at a temperature of 80° C., thereby obtaining a desired nickel plating powder. The thickness of the nickel plating layer of the prepared nickel plating powder was approximately 120 nm. A test was performed on the prepared nickel plating powder, and the results of the test are given in Table 2. FIG. 1 is a photograph of a 1000× magnification of the surface of the plating powder taken using a Scanning Electron Microscope (SEM) in order to determine the uniformity of the surface of the plating powder prepared in Example 1.

1. Uniformity of Plating

The plating uniformity of the surface of the plating powder was determined by magnify the surface of plating powder 100× using a Scanning Electron Microscope (SEM)

2. Measurement of Dispersibility

After 10 g of the plating powder that had been determined in the above plating uniformity was dispersed in ultra-pure water, a dispersibility of the plating powder was measured. In this measurement, the dispersibility, which is represented by the ratio of the amount recovered through a high precision sieve having 4 μm pores to the input amount was calculated using the following equation 2.

Dispersibility (%)=(recovered amount/input amount)×100. Equation 2

3. Measurement of Conductivity

Contact resistance values were measured at the exact time that the particle size of the electroconductive fine particles was compressed to 10% by a fine particle compression electrical resistance measuring instrument (fischer, H100C). An average value of the conductivity was calculated by performing the measurements 10 times.

4. Compactness of Plating

The compactness of plating was examined by magnifying the plated surface of the prepared plating powder to 50K using a Scanning Electron Microscope (SEM) and measuring the sizes of the metal particles. It means that the smaller the sizes of metal particles, the more compact the plating layer that is obtained.

5. Measurement of Adherence

After 1.0 g of the obtained plating powder and 10 g of zirconia beads having a diameter of 5 mm were put into a 100 ml glass bottle to form a mixture, 10 ml of toluene was further added to the mixture, and the mixture was then stirred at a rotation speed of 400 rpm for 10 minutes using a stirrer. After the stirring, the zirconia beads were separated from the stirred mixture, the state of the plating film was evaluated using an optical microscope, and the state was represented as one of the following.

◯: the plating film was not observed to peel off

Δ: the plating film was observed to partially peel off

x: the plating film was observed to peel off

### Example 2

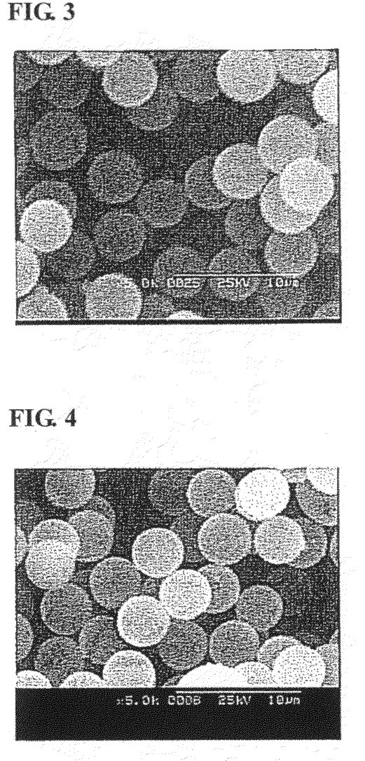

The pre-treatment process was performed as in Example 1, and the plating process was performed using the same method as in Example 1, except that 0.5 g of polyethylene glycol (molecular weight 20,000), which is a surface tension-reducing compound, was input during the plating process. The dispersibility, conductivity, compactness of plating and adherence of the prepared nickel plating powder are given in Table 1. The photograph for determining the uniformity of plating using a Scanning Electron Microscope (SEM is shown in FIG. 2.

### Example 3

The pre-treatment process was performed as in Example 1, and the plating process was performed using the same method as in Example 2, except that the temperature of the plating solution was 40° C. The dispersibility, conductivity, compactness of plating and adherence of the prepared nickel plating powder are given in Table 1. The photograph for determining the uniformity of plating using a Scanning Electron Microscope (SEM) is shown in FIG. 3.

### Example 4

The pre-treatment process was performed as in Example 1, and the plating process was performed using the same method as in Example 1, except that the temperature of the plating solution was 40° C., and 0.5 g of polyethylene glycol (molecular weight 20,000), which is a surface tension-reducing compound, and 0.5 g of nonionic surfactant (tween 80) were added. The dispersibility, conductivity, compactness of plating and adherence of the prepared nickel plating powder are given in Table 1. The photograph for determining the uniformity of plating using a Scanning Electron Microscope (SEM) is shown in FIG. 4.

### Examples 5 and 6

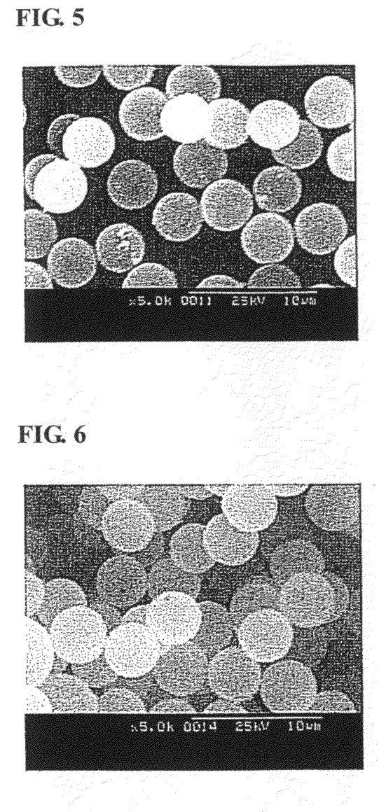

5 g of the nickel plating powder obtained through Examples 3 and 4, and the surfactant and surface tension-reducing compound in Example 4 were added to a substituted gold plating solution (manufactured by HEESUNG METAL LTD., electroless PREP) containing 3.0 g of potassium gold cyanide, and were reacted at a temperature of 60° C. for 20 minutes while being dispersed using an ultrasonic device having a frequency of 37 kHz. The plated thickness was approximately 40 nm. After the reaction, the plating powder was collected from the gold plating solution, was washed in water, and then was dried in a vacuum. The dispersibility, conductivity, compactness of plating and adherence of the prepared nickel plating powder are given in Table 1. The photographs for determining the uniformity of plating using a Scanning Electron Microscope (SEM) are shown in FIGS. 5 and 6.

### Comparative Example 1

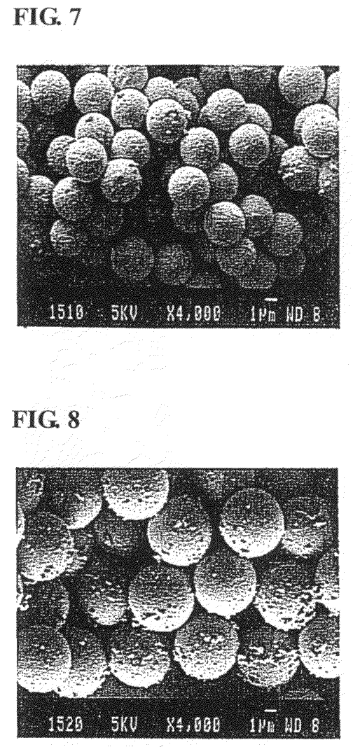

Although the pre-treatment process and the nickel plating process were performed as in Example 1, the nickel plating was performed while the mixture was stirred using a three blade impeller-type stirrer, rather than the ultrasonic device, during the plating process. The dispersibility, conductivity, compactness of plating and adherence of the prepared nickel plating powder are given in Table 1. The photograph for determining the uniformity of plating using a Scanning Electron Microscope (SEM) is shown in FIG. 7.

### Comparative Example 2

Although the pre-treatment process and the nickel plating process were performed as in Example 1, the nickel plating was performed while 0.5 g of polyethylene glycol (molecular weight 20,000), which is a surface tension-reducing compound, and 0.5 g of nonionic surfactant (tween 80) were added and the mixture was stirred using a three blade impeller-type stirrer, rather than the ultrasonic device, during the plating process. The dispersibility, conductivity, compactness of plating and adherence of the prepared nickel plating powder are given in Table 1. The photograph for determining the uniformity of plating using a Scanning Electron Microscope (SEM) is shown in FIG. 8.

### Comparative Example 3

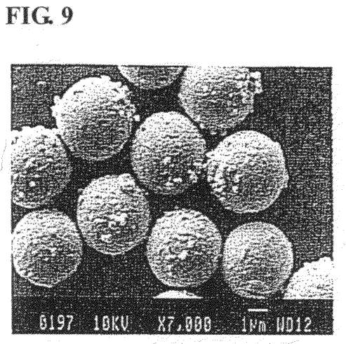

Although the pre-treatment process and the nickel plating process were performed as in Example 1, the nickel plating was performed at a temperature of 40° C. while 0.5 g of polyethylene glycol (molecular weight 20,000), which is a surface tension-reducing compound, and 0.1 g of nonionic surfactant (tween 80) were added and the mixture was stirred using a three blade impeller-type stirrer, rather than the ultrasonic device, during the plating process. The dispersibility, conductivity, compactness of plating and adherence of the prepared nickel plating powder are given in Table 1. The photograph for determining the uniformity of plating using a Scanning Electron Microscope (SEM) is shown in FIG. 9.

TABLE 1

| | Dispersibility | Conductivity | Compactness | adher- |
|---|---|---|---|---|
| | (%) | (Ω/particle) | of plating (nm) | ence |
| Before plating | 100 | — | — | — |
| Example 1 | 85 | 210 | 75 | Δ |
| Example 2 | 87 | 180 | 76 | ∘ |
| Example 3 | 90 | 191 | 45 | ∘ |
| Example 4 | 96 | 206 | 45 | ∘ |
| Example 5 | 95 | 20 | 80 | ∘ |
| Example 6 | 96 | 20 | 80 | ∘ |
| Comparative | 43 | 253 | 160 | x |
| example 1 | | | | |
| Comparative | 42 | 284 | 150 | x |
| example 2 | | | | |
| Comparative | 46 | 249 | 145 | x |
| example 3 | | | | |

As clearly appreciated from the results shown in Table 1 and FIGS. 1 to 9, the method according to the present invention, compared to the conventional method, has advantages in that, an aggregation phenomenon does not occur on the surface of fine particles during plating with the fine particles, so that post-treatment processes are not necessary, and a plating reaction can be performed at low temperature, so that it is possible to obtain a compact and uniform plating layer, and plating powder having low electrical resistance can be obtained.

1. A method of producing electroconductive electroless plating powder having excellent dispersibility and adherence, using an electroless plating method of forming a metal plating layer on a surface of a base material made of resin powder in an electroless plating solution, wherein an ultrasonic treatment is performed at a time of forming the plating layer.

2. The method according to claim 1, wherein the base material made of the resin powder has an average particle size of 0.5˜1000 μm, an aspect ratio of less than 2 and a coefficient of variation Cv of the particle size of 30% or less, the Cv being defined by the following equation:
Cv (%)=(σ/Dn)×100 Equation 1
wherein σ is a standard deviation of the particle size, and Dn is a number average particle size.

3. The method according to claim 1, wherein the ultrasonic waves have a frequency of 20˜1000 kHz.

4. The method according to claim 1, wherein the plating solution comprises a surface tension-reducing compound ranging from 0.1˜10000 ppm.

5. The method according to claim 1, wherein temperature of the electroless plating solution is in a range of 40˜70° C.

6. The method according to claim 2, wherein the resin comprise one or a mixture of two or more selected from the group consisting of polyethylene, polyvinylchloride, polypropylene, polystyrene, polyisobutylene, styrene-acrylonitrile copolymer, acrylonitrile-butadiene-styrene terpolymer, poly acrylate, poly methyl methacrylate, poly acrylamide, polyvinyl acetate, polyvinyl alcohol, poly acetal, polyethylene glycol, polypropylene glycol, epoxy resin, benzoguanamine, urea, thio urea, melamine, acetoguanamine, dicyan amide, aniline, formaldehyde, palladium formaldehyde, acetaldehyde, polyurethane and polyester.

7. The method according to claim 4, wherein the surface tension-reducing compound comprises one or a mixture of two or more selected from the group consisting of polyethylene glycol, polyalkylene alkyl ether, polyalkylene alkyl ethyl and polyvinylpyrrolidone.
